(19) United States
(12) Patent Application Publication
(10) Pub. No.: US 2007/0122530 A1
(43) Pub. Date: May 31, 2007

(54) METHOD AND APPARATUS FOR CUTTING A CAKE OR OTHER PENETRABLE OBJECT INTO A DESIRED SHAPE

(76) Inventor: Pauline Mary Curley, Clifton, NJ (US)

Correspondence Address: STANLEY H. KREMEN, 4 LENAPE LANE, EAST BRUNSWICK, NJ, 08816, US

(21) Appl. No.: 11/676,440

(22) Filed: Feb. 19, 2007

Related U.S. Application Data
(60) Provisional application No. 60/780,249, filed on Mar. 8, 2006.

(51) Int. Cl. A23G 1/00

(52) U.S. Cl. 426/104; 426/518

(57) ABSTRACT

A template device used to easily and precisely cut a baked cake into decorative shapes such as numbers, letters and holiday symbols. The device comprises a durable, kitchen-friendly material such as melamine, metal or plastic. It allows anyone skilled or unskilled in cake decorating to easily create a cut-shaped cake without fear of mistake. One places the template on top of the baked cake, and then cuts it using the edge as a guide for the knife or other cutting implement. The template can have cleats extending from the contact surface into the cake. This template remains in position until the cutting operation is complete and the template is removed from the cake. The template can also have a handle on the non-contacting face that would make positioning the template on the cake and removal of the template after cutting more convenient. Finally, the template can have a shaped flange extending perpendicular from the contact surface into the cake for a short distance. This flange will score the cake using the desired shape, and the cutting will proceed along the edge of the template with the flange acting as a cutting guide.

### CROSS REFERENCE TO RELATED APPLICATIONS

This Present Application is the non-provisional counterpart of U.S. Provisional Patent Application Ser. No. 60/780,249, filed on Mar. 8, 2006. The Present Application claims the benefit of and priority to said Provisional Application which is incorporated herein by reference in its entirety.

### BACKGROUND

Baked cakes have been popular confections for centuries and their manner of preparation has changed only slightly in that time. As a baked product, the cake has a relatively solid consistency which allows for bakers or cake decorators to apply decorative features such as painting on images in frosting or layers of cake separated by layers of frosting or tiered structures separated by support columns which are usually inedible. This has led to cakes in modern times to be seen as both a tasty treat and a decorative piece tailored to the celebration at which it is presented.

Though it is now common to see innovative techniques of applying images directly onto cakes, there is still one part of the cake decorating process that remains almost unchanged. The process of actually shaping the cake itself is most often performed by cutting the cooked cake into the desired shape. This is not an easy process, as it requires a good deal of skill to exactly cut the desired shape without making a mistake which would require the baker to start over again with a new cake.

Attempts have been made to incorporate a cutting guide into the pan such that a straightedge may be placed over pegs located along the edge of the pan to allow for straight cuts in the cake, but this does little good for irregular rounded shapes, such as a racecar or number for a child's birthday.

This invention provides an easy solution for designing and making novelty party cakes in the home. Initially conceived for children's birthday cakes, the idea has been expanded to include cakes for other occasions such as adults birthdays, anniversaries, and holidays.

### DISCUSSION OF THE PRIOR ART

To ease the necessity of bakers having acquired skills in cutting cakes into specific shapes, shaped cooking pans were originally innovated. Shaped birthday cakes are usually made in cake-pan molds (for example character shape pans available on the market like Winnie the Pooh, Dora the Explorer and Thomas the Tank Engine). The liquid batter of the uncooked cake is poured into a shaped pan which results in the cake being baked into the desired outline. However, the cakes made in such molds are often difficult to remove without leaving bits of cake stuck behind on the base of the pan. These cakes also require additional time-consuming decorating to achieve the desired effect. This invention provides a simple and easy method of producing an interesting and appealing (and infinitely reusable) alternative for home-made party cakes.

The shaped pan has an immediately obvious fault in that it requires the baker to procure specialty cooking pans covering a wide variety of shapes which may be requested by a patron. This is often too costly and impractical, which forces bakers to rely on the technique of manually cutting the cake. Thus, very little practical improvement has been seen in this aspect of baking.

The Present Invention overcomes these drawbacks by providing a way for the baker to easily and accurately cut the cake into the desired shape without having to rely on bulky, expensive custom-made shaped pans which are difficult to store. The Present Invention, in its preferred embodiment, would act as a template placed on top of a baked cake. The template would be of a durable material resistant to being cut by the baker's knife as the baker follows the outline of the template to cut off the excess cake.

Furthermore, the device could have short (½″) skewers or cleats placed strategically on one side of the template so as to pierce the cake and firmly attach the template to the cake's surface. This will prevent the template from sliding which could result in the baker making a mistake. The template and the skewers could be of different materials, but in the preferred embodiment, the cleats could easily fold flat to template to allow for easy storage. Upon completion of the cutting process, the template may be easily lifted from the shaped cake leaving only tiny holes behind where the cleats pierced the cake which could be easily covered by frosting.

Another embodiment of the Present Invention would have a thin flange perpendicular to the template, which would make it appear as a very shallow (¼″) pan. When pressed into the surface of the cake, the flange would penetrate the cake and score it in the shape of the template. Afterwards, the template may be removed and the baker may follow the scoring with a sharp knife to achieve the desired shape. On the other hand, the flange may be used as a cutting guide to achieve the desired shape.

### BRIEF DESCRIPTION OF THE DRAWINGS

FIG. 1 is a top plan view of templates having numerical shapes.

FIG. 2 is a top plan view of various shaped templates.

FIG. 3 is an isometric view showing a template with a flange.

FIG. 4 is a top plan view of templates having numerical shapes, each template having a handle.

FIG. 5 is an isometric view showing the template of FIG. 3 with a handle.

### SUMMARY OF THE INVENTION

The Present Invention is disclosed in two formats, viz., a method for cutting a cake into a desired shape using a template and the physical template used to cut the cake. The template comprises an essentially two-dimensional object having two faces and at least one edge. One of the two faces is adapted to be in contact with the cake, while the other face does not touch the cake. One places the template on top of the cake, and then cuts it using the edge as a guide for the knife or other cutting implement. The template can have cleats extending from the contact surface into the cake. This template remains in position until the cutting operation is complete and the template is removed from the cake. The template can also have a handle on the non-contacting face that would make positioning the template on the cake and removal of the template after cutting more convenient. Finally, the template can have a shaped flange extending perpendicular from the contact surface into the cake for a short distance. This flange will score the cake using the desired shape, and the cutting will proceed along the edge of the template with the flange acting as a cutting guide. Conversely, the template may be removed after scoring, and the cake may be cut along the score marks using a sharp knife or other cutting implement.

### DETAILED DESCRIPTION OF THE INVENTION

While the Present Invention is presented in the drawings and the description in its preferred embodiment, it should be understood that it is not limited to this single example. Those skilled in the art will be able to perceive this embodiment and deduce additional embodiments. In particular, the term cake in this disclosure can also refer to any penetrable object. Sometimes, a cake may be decorative and not edible. Such a cake could by made from Styrofoam™ or Plasticine™. In fact, the cake can be any sculptured object. The only requirement is that the cake must have appreciable volume. For the purposes of this invention, a cake is not a flat cookie.

A cake is baked in the traditional manner in a pan with dimensions greater than or equal to that of the Present Invention. The templates may be made in a variety of sizes to accommodate larger and smaller pans, but the traditional 13″×9″ pan is preferable. After removing the cake from the cooking pan and allowing it to cool and become firm so as to be easily handled, the baker would place the Present Invention on top of the cake so that the outline of the template falls entirely within the area of the cake. In this way, the wasted cake material is minimized.

Light pressure is applied around the edge of the template so as to push the lip around the edge of the template into the cake's surface, thereby scoring the cake in the shape of the template. The template is then pulled off of the cake by the handle and the scoring is left on the cake as a visual guide for the baker to cut off the excess portions of the cake around the desired shape. Afterwards, the cake may be decorated in the traditional manner if cake decoration is desired.

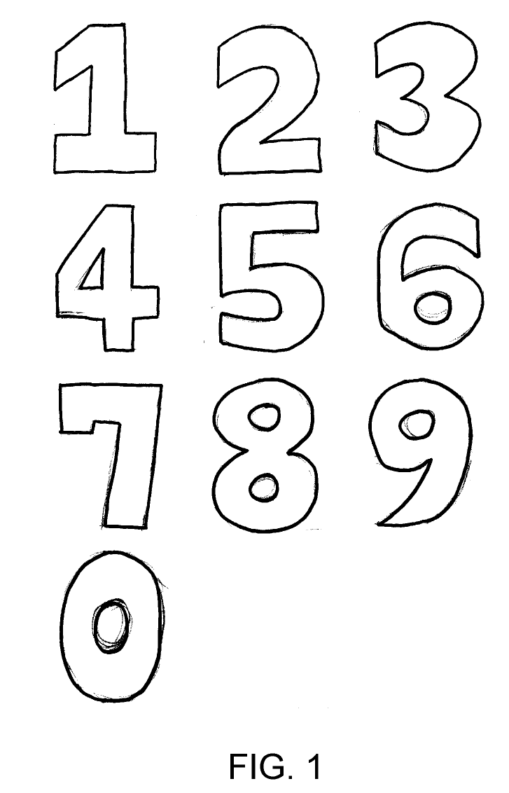

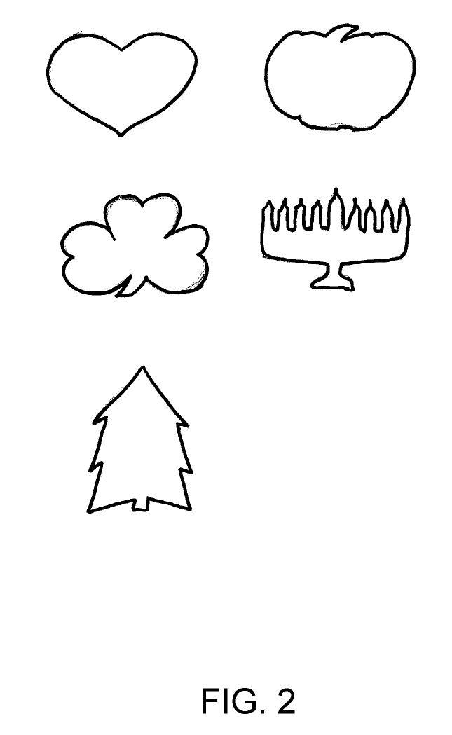

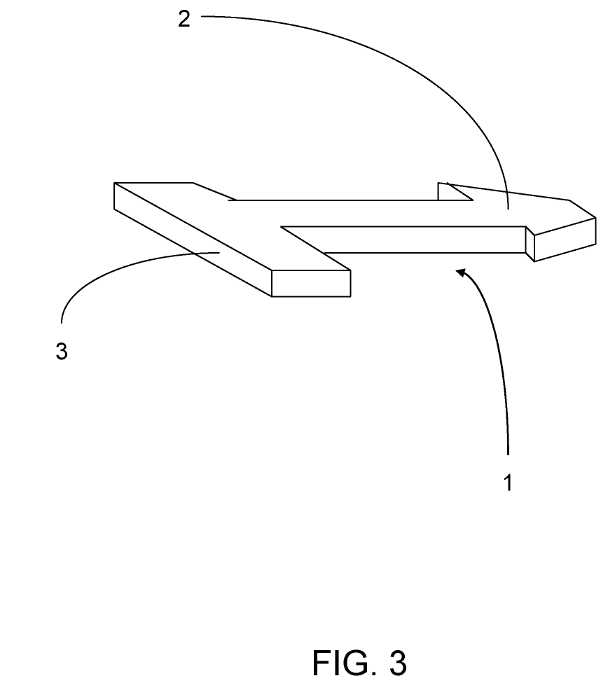

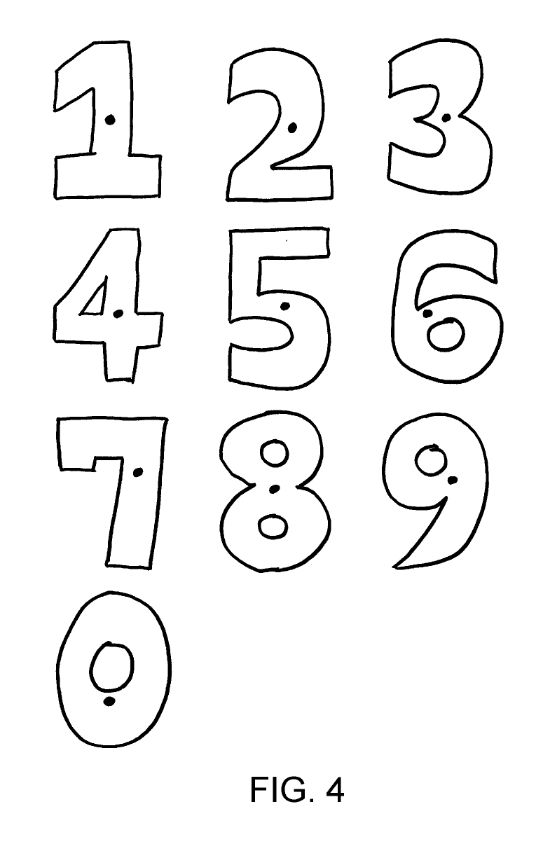

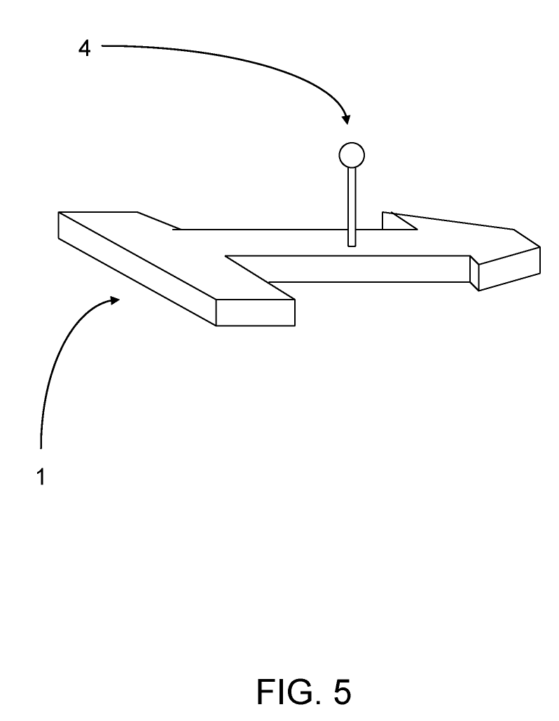

FIGS. 1-5 indicate the embodiments of this invention. FIG. 1 and FIG. 2 illustrate the first embodiment—a flat template cut in a specific shape that is placed over a cake as a cutting guide. FIG. 1 shows the templates cut into numerals while FIG. 2 shows them cut into other decorative shapes. FIG. 3 illustrates the second embodiment—a flat template with a flange angled perpendicularly to the plane of the template in the downward direction. FIG. 4 and FIG. 5 illustrate the third embodiment—the numeric templates of either the first or second embodiments with a knob for gripping positioned on the top and middle of the template. FIG. 4 indicates where the knob could be positioned on numeral templates. FIG. 5 is an isometric view of the third embodiment.

I claim:

1. A method for cutting a penetrable object having volume and depth into a desired shape comprising:
a) placing a template, having two faces and an outside edge or edges that form the desired shape, onto the top of the penetrable object, such that one face makes contact with the penetrable object surface and the other face does not touch the penetrable object surface;
b) using the outside edge or edges as a guide for placement of a cutting instrument into the penetrable object; and,
c) cutting the penetrable object only along the outside edge or edges of the template while using the template as a guide for cutting.

2. The method of claim 1 wherein the template is planar.

3. The method of claim 1 wherein the template is rigid.

4. The method of claim 1 wherein the template is flexible.

5. The method of claim 1 wherein the template further comprises a handle for placing and removing the template from the penetrable object, said handle being attached to the non-contacting surface of the template.

6. The method of claim 1 wherein the template further comprises cleats attached to the contacting surface of the template such that the cleats extend into the penetrable object.

7. The method of claim 1 further comprising first scoring and then cutting the penetrable object with the template, wherein:
the template further comprises a flange having an inner surface and an outer surface, said flange surfaces extending perpendicular to the contacting face at the outer edge or edges, said flange forming the desired shape; and,
the flange extends from the contacting face into the penetrable object to a distance shorter than the depth of the penetrable object; and,

8. The method of claim 7 further comprising cutting the penetrable object along the outside edge of the template while also using the flange as a guide for cutting.

9. The method of claim 7 further comprising removing the template from the penetrable object, and then cutting it using the scoring as a guide for cutting.

10. A template for cutting a penetrable object having volume and depth into a desired shape, said template comprising:
a) a contacting face adapted to be placed in contact with the penetrable object;
b) a non-contacting face;
c) an edge or edges forming the desired shape;
d) cleats extending perpendicular to the contacting face wherein said cleats are adapted to extend into the penetrable object.

11. The template of claim 10 further comprising a handle attached to the non-contacting face.

12. The template of claim 10 further comprising a flange extending from the contacting face and adapted to extend into the penetrable object to a distance shorter than the depth of the penetrable object for the purpose of scoring the penetrable object prior to cutting.
